(19) United States
(12) Patent Application Publication
(10) Pub. No.: US 2025/0047046 A1
(43) Pub. Date: Feb. 6, 2025

(54) COAXIAL CONNECTOR DEVICE

(71) Applicant: Japan Aviation Electronics Industry, Ltd., Tokyo (JP)

(72) Inventors: Takeharu NAITO, Tokyo (JP); Kazuki ISHII, Tokyo (JP)

(21) Appl. No.: 18/791,739

(22) Filed: Aug. 1, 2024

(30) Foreign Application Priority Data
Aug. 2, 2023 (JP) 2023-126205

(51) Int. Cl. H01R 24/40; H01R 13/502; H01R 103/00

(52) U.S. Cl. CPC H01R 24/40; H01R 13/502; H01R 2103/00

(57) ABSTRACT

A coaxial connector device includes an external housing containing an insulator, and a die-cast member containing a conductor. The external housing includes a body part and an L-shaped part including a first extension part extending in +x axis direction from an end surface of the body part on the +x axis direction side, and a second extension part extending in +z axis direction from an end of the first extension part on the +x axis direction side. The die-cast member includes a body part and an L-shaped groove including a first groove part and a second groove part.

### INCORPORATION BY REFERENCE

This application is based upon and claims the benefit of priority from Japanese patent application No. 2023-126205, filed on Aug. 2, 2023, the disclosure of which is incorporated herein in its entirety by reference.

### BACKGROUND

The present disclosure relates to a coaxial connector device.

In an on-vehicle coaxial connector where a housing to which a cable is attached is connected to a connector, a high level of specification is required for the retention of the housing; especially, the retention in the horizontal direction in which the cable extends when the cable is pulled, in terms of connection reliability.

### SUMMARY

As shown in FIG. 16, in a connector as disclosed in European Patent Publication No. 3944428, for example, a die-cast and a housing have a press-fit retention structure. Since the press-fit retention structure has a structure where the housing is detached when a cable connected to the housing is pulled, it is difficult to improve the connection reliability.

The present disclosure has been accomplished to solve the above problem, and an object of the present disclosure is thus to provide a coaxial connector device with improved connection reliability.

According to an aspect of the present disclosure, a coaxial connector device includes an external housing containing an insulator; and a die-cast member containing a conductor, the external housing and the die-cast member adjacent and connected each other in a first direction parallel to an axial direction, wherein the external housing includes a first body part; and an L-shaped part including a first extension part extending from an end surface of the first body part on one side in the first direction toward the one side in the first direction, and a second extension part extending from an end of the first extension part on the one side in the first direction toward one side in a second direction orthogonal to the first direction, the die-cast member includes a second body part; and an L-shaped groove including a first groove part extending from an end surface of the second body part on another side in the first direction toward the one side in the first direction, and a second groove part extending from an end of the first groove part on the one side in the first direction toward the one side in the second direction, and a surface of the second extension part on another side in the first direction is in contact with a surface of the second groove part facing the one side in the first direction.

In the above-described coaxial connector device, the L-shaped groove may be formed in at least one of a surface of the second body part on one side in a third direction orthogonal to the first direction and the second direction and a surface of the second body part on another side in the third direction, and the L-shaped part may be disposed on at least one of the one side in the third direction and the another side in the third direction in a surface of the second body part on the one side in the first direction.

In the above-described coaxial connector device, the L-shaped groove may be formed in such a way that after the second extension part of the L-shaped part is inserted into the first groove part of the L-shaped groove on the one side in the first direction, the second extension part of the L-shaped part is inserted into the second groove part of the L-shaped groove on the one side in the second direction.

The above-described coaxial connector device may further include a shielding shell containing the conductor, wherein the shielding shell includes a third body part disposed on a surface of the second body part on the one side in the second direction, a spring member in spring shape connected to the third body part, a cover part extending from at least one of an end of the third body part on the one side in the third direction and an end of the third body part on the another side in the third direction toward another side in the second direction, and configured to cover the L-shaped part in the third direction, and a fitting part formed at an end of the cover part and configured to be fit into a recess of the L-shaped part.

In the above-described coaxial connector device, the spring member and the die-cast member may be connected to a ground potential.

The above-described coaxial connector device may further include a contact containing the conductor, and a housing containing the insulator, wherein a part of the housing extending in the axial direction is disposed between a part of the contact extending in the axial direction and the die-cast member.

According to the present disclosure, there is provided a coaxial connector device with improved connection reliability.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view illustrating each member included in a coaxial connector device according to a comparative example;

FIG. 2 is a sectional view illustrating an assembly of the coaxial connector device according to the comparative example;

FIG. 3 is a side view illustrating the operation of connecting an external housing and a die-cast member in the coaxial connector device according to the comparative example;

FIG. 4 is a side view illustrating the operation of connecting the external housing and the die-cast member in the coaxial connector device according to the comparative example;

FIG. 5 is a side view illustrating the operation of connecting the external housing and the die-cast member in the coaxial connector device according to the comparative example;

FIG. 6 is a perspective view illustrating each member included in a coaxial connector device according to a first embodiment;

FIG. 7 is a side view illustrating the operation of connecting an external housing and a die-cast member in the coaxial connector device according to the first embodiment;

FIG. 8 is a side view illustrating the operation of connecting the external housing and the die-cast member in the coaxial connector device according to the first embodiment;

FIG. 9 is a side view illustrating the operation of connecting the external housing and the die-cast member in the coaxial connector device according to the first embodiment;

FIG. 10 is a perspective view illustrating the external housing in the coaxial connector device according to the first embodiment;

FIG. 11 is a perspective view illustrating the die-cast member in the coaxial connector device according to the first embodiment;

FIG. 12 is a side view illustrating the coaxial connector device according to the first embodiment;

FIG. 13 is a sectional view illustrating the coaxial connector device according to the first embodiment, which shows a cross section along line XIII-XIII in FIG. 12;

FIG. 14 is a sectional view illustrating a fitting part in the coaxial connector device according to the first embodiment, which shows an enlarged view of a part XIV in FIG. 13;

FIG. 15 is a side view illustrating a contact unit in the coaxial connector device according to the first embodiment; and

FIG. 16 is a perspective view illustrating a terminal of a connector according to related art.

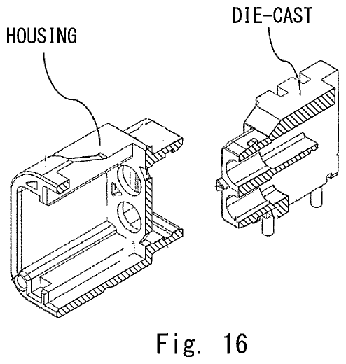

### DESCRIPTION OF EMBODIMENTS

A specific structure of the present disclosure will be described hereinbelow with reference to the drawings. The description provided hereinbelow merely illustrates preferred embodiments of the present disclosure, and the present disclosure is not limited to the below-described embodiments. In the following description, the identical reference symbols denote substantially identical elements. For clarity of the drawings, some reference symbols and hatching are omitted.

Prior to describing a coaxial connector device according to a first embodiment, a coaxial connector device according to a comparative example will be described for comparison. This will clarify the features of the coaxial connector device according to the first embodiment.

### Comparative Example

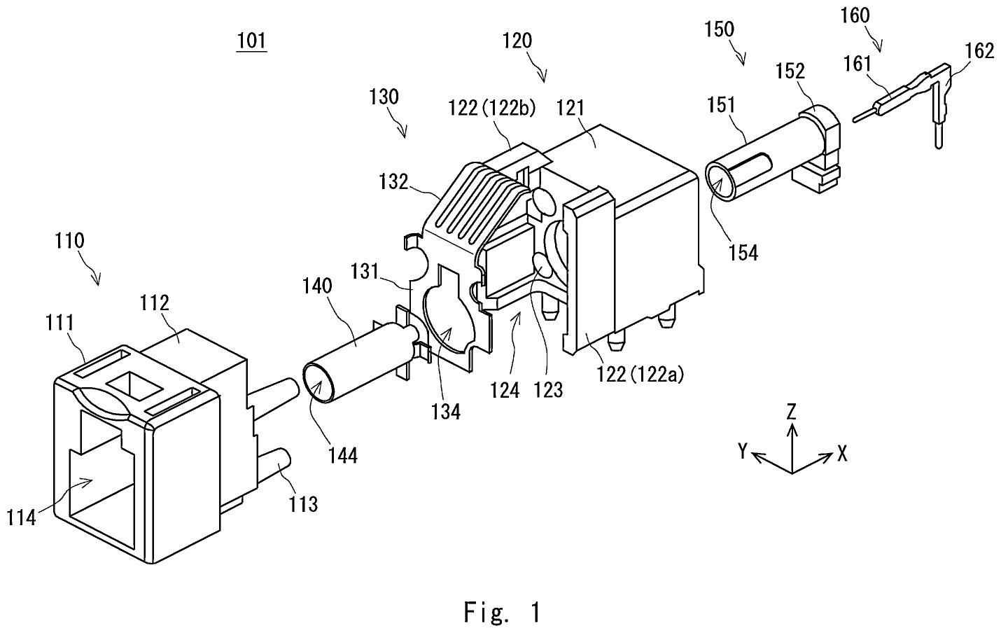

FIG. 1 is a perspective view illustrating each member included in a coaxial connector device 101 according to a comparative example. As shown in FIG. 1, the coaxial connector device 101 according to the comparative example includes an external housing 110, a die-cast member 120, a shielding shell 130, a GND shell member 140, an internal housing 150, and a contact 160.

For the convenience of description of the coaxial connector device 101 and a coaxial connector device 1, which is described later, the xyz-orthogonal coordinate axis system is used. For example, the axial direction of the coaxial connector device 101 or the like is referred to as x axis direction, and two directions orthogonal to the x axis are referred to as y axis direction and Z axis direction. In some cases, +Z axis direction is called upward, and a surface on the +Z axis direction side is called a top surface. Further, −Z axis direction is called downward, and a surface on the −z axis direction side is called an under surface. In some cases, +y axis direction and −y axis direction are called sideward, and a surface on the +y axis direction side and a surface on the −y axis direction side are called side surfaces. Note that upward, downward, top surface, down surface, sideward, and side surface are terms to be used for the convenience of description of the coaxial connector device 101 or the like, and they do not indicate the direction in which the coaxial connector device 101 or the like is disposed. Each structure is described hereinafter.

### <External Housing>

The external housing 110 has a tube shape. For example, the external housing 110 has a square tube shape. The external housing 110 includes a body part 111 and an insertion part 112. The body part 111 includes a part on the −x axis direction side of the external housing 110. The insertion part 112 includes a part on the +x axis direction side of the external housing 110. The width in the y axis direction and the width in the z axis direction of the body part 111 are greater than the width in the y axis direction and the width in the z axis direction of the insertion part 112. The insertion part 112 is configured to mate with a mating part 122 that is disposed on the −x axis direction side of the die-cast member 120. To be specific, the insertion part 112 is to be fit between a mating plate 122a and a mating plate 122b.

A projection 113 extending on the +x axis direction side is formed on an end surface of the insertion part 112 on the +x axis direction side. A plurality of projections 113 may be formed. The projection 113 is configured to be inserted into an insertion hole 123 in the die-cast member 120 when the insertion part 112 mates with the mating part 122 of the die-cast member 120.

The external housing 110 has a penetrating hole 114 that penetrates it from an end surface of the body part 111 on the −x axis direction side to an end surface of the insertion part 112 on the +x axis direction side. The penetrating hole 114 is disposed in such a way that its center axis is in the x axis direction. Members such as the GND shell member 140, the internal housing 150, and the contact 160 are to be inserted into the penetrating hole 114.

The external housing 110 contains an insulator as a material. For example, the external housing 110 contains a resin as a material. Note that the external housing 110 may contain an insulator other than a resin as long as it contains an insulator.

### <Die-Cast Member>

The die-cast member 120 includes the body part 121 and the mating part 122. The mating part 122 is connected to an end surface of the body part 121 on the −x axis direction side. The mating part 122 includes two plate-shaped mating plates 122a and 122b opposed to each other in the y axis direction. The mating plate 122a is disposed on the −y axis direction side in the end surface of the body part 121 on the −x axis direction side, and the mating plate 122b is disposed on the +y axis direction side in the end surface of the body part 121 on the −x axis direction side. The insertion part 112 of the external housing 110 is fit between the two mating plates 122a and 122b. To be specific, the insertion part 112 of the external housing 110 is fit between the two mating plates 122a and 122b with the shielding shell 130 interposed therebetween.

An insertion hole 123 is formed on the end surface of the body part 121 on the −x axis direction side. The same number of insertion holes 123 as the projections 113 may be formed. The insertion hole 123 is for the projection 113 of the external housing 110 to be inserted.

The die-cast member 120 has a penetrating hole 124 that penetrates it from an end surface of the body part 121 on the −x axis direction side to an end surface of the body part 121 on the +x axis direction side. The penetrating hole 124 is disposed in such a way that its center axis is in the x axis direction. The insertion hole 123 and the penetrating hole 124 are formed between parts where the mating plates 122a and 122b are connected in the end surface of the body part 121 on the −x axis direction side. Members such as the GND shell member 140, the internal housing 150, and the contact 160 are to be inserted into the penetrating hole 124.

The die-cast member 120 contains a conductor as a material. For example, the die-cast member 120 may include a metal such as aluminum and zinc as a material. The die-cast member 120 may be manufactured by die casting. The die-cast member 120 is electrically connected to a ground (GND), together with the shielding shell 130. A connection structure for connecting to a specified board may be formed on the −z axis direction side of the die-cast member 120.

### <Shielding Shell>

The shielding shell 130 includes a plate-shaped part 131 in plate shape and a spring part 132 in spring shape. The plate-shaped part 131 has a plate surface on the +x axis direction side and a plate surface on the −x axis direction side. The plate-shaped part 131 has a penetrating hole 134 that penetrates the plate surface. The penetrating hole 134 is disposed in such a way that its center axis is in the x axis direction. The spring part 132 is connected to an end of the plate-shaped part 131 on the +z axis direction side. The spring part 132 has a plate shape, for example. The spring part 132 is disposed in such a way that its plate surface is inclined against the XY plane. The spring part 132 has spring elasticity. The spring part 132 can bend in the z axis direction.

The plate-shaped part 131 is disposed on the end surface of the body part 121 on the −x axis direction side in the die-cast member 120. Thus, the plate-shaped part 131 is disposed between the mating plate 122a and the mating plate 122b. The penetrating hole 134 in the plate-shaped part 131 is disposed to surround the penetrating hole 124. The insertion part 112 of the external housing 110 is disposed on the −x axis direction side of the plate-shaped part 131. The spring part 132 is disposed on a top surface of the body part 121 of the die-cast member 120.

The shielding shell 130 contains a conductor as a material. For example, the shielding shell 130 contains a metal as a material. The shielding shell 130 is electrically connected to the ground (GND), together with the die-cast member 120.

### <GND Shell Member>

The GND shell member 140 has a tube shape having a penetrating hole 144 that penetrates it in the x axis direction, for example. The penetrating hole 144 is disposed in such a way that its center axis is in the x axis direction. The GND shell member 140 has a cylindrical shape, for example. The GND shell member 140 is disposed inside the penetrating hole 114, the penetrating hole 134 and the penetrating hole 124 that communicate as the external housing 110, the plate-shaped part 131 and the die-cast member 120 are placed on top of one another in the x axis direction. The internal housing 150 into which the contact 160 is press-fit is to be inserted into the GND shell member 140.

The GND shell member 140 contains a conductor as a material. For example, the GND shell member 140 contains a metal as a material. The GND shell member 140 is electrically connected to the ground (GND), together with the die-cast member 120 and the shielding shell 130.

### <Internal Housing>

The internal housing 150 includes a tubular part 151 and a support part 152. The tubular part 151 has a cylindrical shape, for example. Note that the tubular part 151 is not limited to be cylindrical as long as it is tubular. The tubular part 151 is disposed in such a way that its center axis is in the x axis direction. The tubular part 151 has a penetrating hole 154 that penetrates it from an end on the +x axis direction side to an end on the −x axis direction side. Thus, the penetrating hole 154 is disposed in such a way that its center axis is in the x axis direction.

The support part 152 is connected to the +x axis direction side of the tubular part 151. The support part 152 is in plate shape extending in the z axis direction, which has plate surfaces facing the +x axis direction side and the −x axis direction side. The tubular part 151 is connected to an end on the +z axis direction side in the plate surface of the support part 152 on the −x axis direction side. Thus, when viewed from the y axis direction, the internal housing 150 is L-shaped. The support part 152 has, at an end on the +z axis direction side, a penetrating hole 154 that penetrates it from the plate surface on the +x axis direction side to the plate surface on the −x axis direction side. The penetrating hole 154 of the support part 152 communicates with the penetrating hole 154 of the tubular part 151. The contact 160 is to be press-fit into the communicating penetrating hole 154. Further, a groove with which the contact 160 is to mate may be formed on the plate surface of the support part 152 on the +x axis direction side. The groove extends from the penetrating hole 154 to the −z axis direction side on the plate surface of the support part 152 on the +x axis direction side.

The internal housing 150 contains an insulator as a material. For example, the internal housing 150 contains a resin as a material. Note that the internal housing 150 may contain an insulator other than a resin as long as it contains an insulator.

### <Contact>

The contact 160 is in L shape having a part extending in the x axis direction and a part extending in the z axis direction. The part extending in the x axis direction is referred to as a first bar-shaped part 161, and the part extending in the z axis direction is referred to as a second bar-shaped part 162. An end of the first bar-shaped part 161 on the +x axis direction side is connected to an end of the second bar-shaped part 162 on the +z axis direction side.

The first bar-shaped part 161 includes a distal end part, a middle part, and a root part, for example, sequentially from the −x axis direction side. The distal end part has a round bar shape. A distal end of the distal end part is rounded in hemispherical shape. The middle part and the root part have a square bar shape. The width between opposed side surfaces of the middle part and the root part in square bar shape is greater than the outside diameter of the distal end part in round bar shape. The middle part and the root part have a projection on their side surfaces.

The first bar-shaped part 161 in the contact 160 is press-fit into the penetrating hole 154 of the internal housing 150. Such a press-fitting process of a contact requires a projection for retention in press-fitting.

The second bar-shaped part 162 includes a distal end part, a middle part, and a root part, for example, sequentially from the −z axis direction side. The distal end part has a round bar shape. A distal end of the distal end part is rounded in hemispherical shape. The distal end part is connected to a specified board that is disposed on the −z axis direction side. The middle part and the root part have a square bar shape. The width between opposed side surfaces of the middle part and the root part in square bar shape is greater than the outside diameter of the distal end part in round bar shape.

The contact 160 contains a conductor as a material. For example, the contact 160 contains a metal as a material. The contact 160 serves as a transmission path of a high-frequency signal.

### <Method of Assembly>

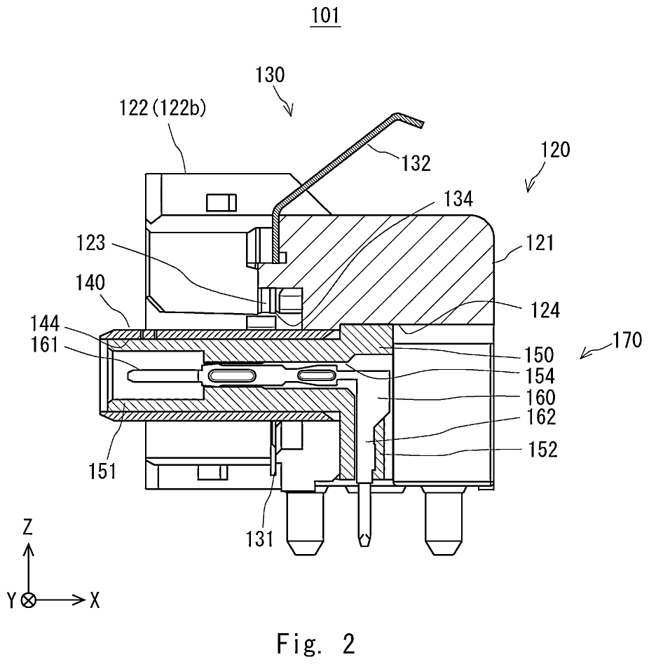

FIG. 2 is a sectional view illustrating an assembly of the coaxial connector device 101 according to the comparative example. Note that the external housing 110 is omitted in FIG. 2. As shown in FIG. 2, the first bar-shaped part 161 of the contact 160 is press-fit into the penetrating hole 154 of the internal housing 150 in the −x axis direction. The internal housing 150 into which the contact 160 is press-fit is referred to as a contact unit 170. Thus, the contact unit 170 includes the contact 160 and the internal housing 150.

The contact unit 170 is press-fit into the penetrating hole 144 of the GND shell member 140. The GND shell member 140 is inserted into the penetrating hole 124 of the die-cast member 120 and the penetrating hole 134 of the shielding shell 130 in the −x axis direction.

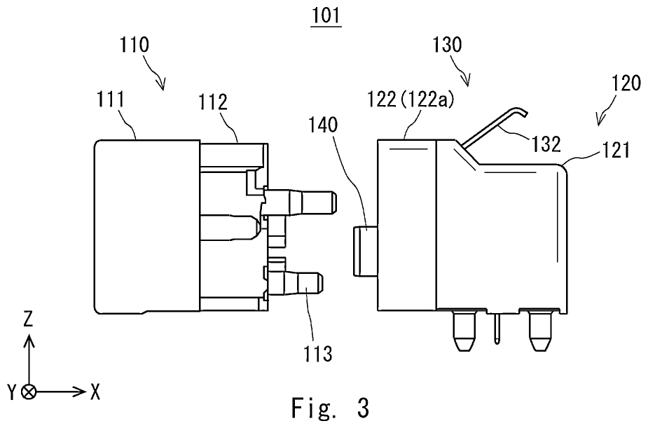

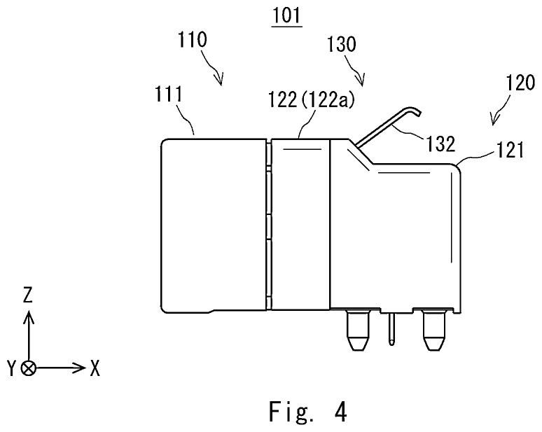

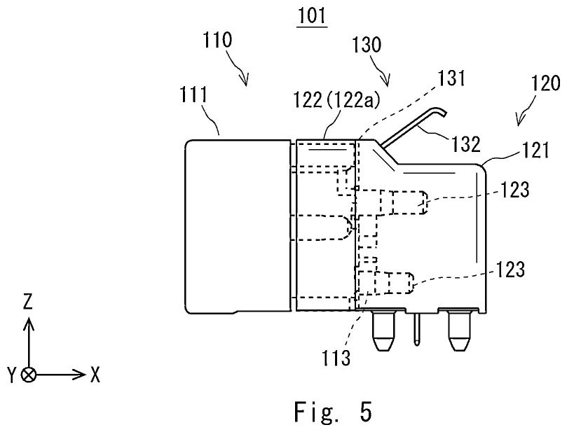

FIGS. 3 to 5 are side views illustrating the operation of connecting the external housing 110 and the die-cast member 120 in the coaxial connector device 101 according to the comparative example. As shown in FIGS. 3 and 4, the insertion part 112 of the external housing 110 is fit between the two mating plates 122a and 122b of the die-cast member 120 with the shielding shell 130 interposed therebetween. In this process, as shown in FIG. 5, the projection 113 of the external housing 110 is press-fit into the insertion hole 123 of the die-cast member 120. The GND shell member 140 that contains the internal housing 150 and the contact 160 are inserted into the penetrating hole 114 of the external housing 110.

### Problem in Comparative Example

In the coaxial connector device 101 according to the comparative example, the external housing 110 and the die-cast member 120 are connected by press-fitting the projection 113 of the external housing 110 into the insertion hole 123 of the die-cast member 120. In such a retention structure by press-fitting of the external housing 110, it is difficult to improve the retention in the x axis direction. For example, when a cable is connected to the −x axis direction side of the external housing 110, the direction in which the cable extends and the press-fit direction are in opposite directions. Thus, the housing 110 can be detached when the cable is pulled. It is therefore difficult to improve the connection reliability in the coaxial connector device 101 according to the comparative example, and a connection structure capable of improving the retention between the external housing 110 and the die-cast member 120 is desired.

### First Embodiment

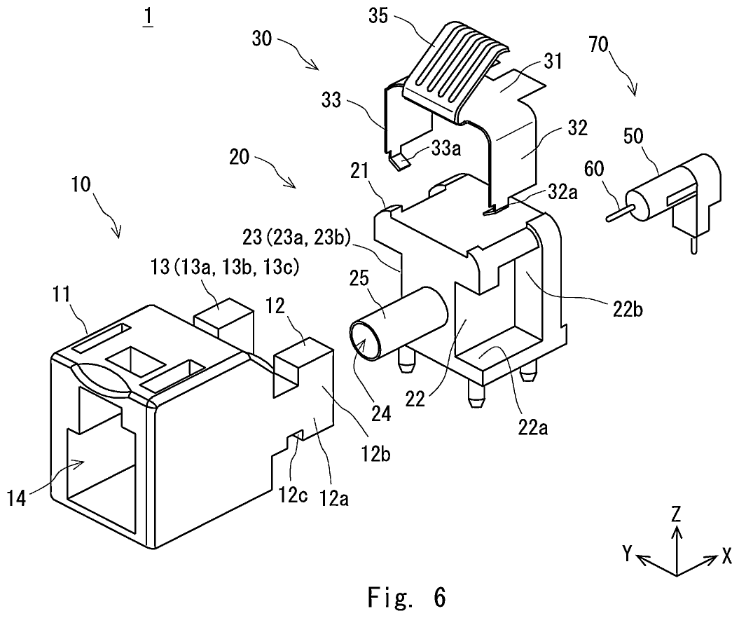

A coaxial connector device according to a first embodiment will be described hereinafter. FIG. 6 is a perspective view illustrating each member included in a coaxial connector device 1 according to the first embodiment. As shown in FIG. 6, the coaxial connector device 1 according to this embodiment includes an external housing 10, a die-cast member 20, a shielding shell 30, and a contact unit 70.

### <External Housing>

The external housing 10 has a tube shape. For example, the external housing 10 has a square tube shape. The external housing 10 includes a body part 11 and L-shaped parts 12 and 13. The L-shaped parts 12 and 13 are connected an end surface of the body part 11 on the +x axis direction side. The L-shaped parts 12 and 13 function as a mating part configured to mate with the die-cast member 20.

The body part 11 has a penetrating hole 14 that penetrates it from an end surface on the −x axis direction side to an end surface on the +x axis direction side. Thus, the external housing 10 has the penetrating hole 14 that penetrates it in the x axis direction. Members such as a cylindrical part 25 of the die-cast member 20 and the contact unit 70 are to be inserted into the penetrating hole 14. The L-shaped parts 12 and 13 are disposed in parallel in the y axis direction on the end surface of the body part 11 on the +x axis direction side. The L-shaped parts 12 and 13 are disposed at both ends of the penetrating hole 14 in the y axis direction in the end surface of the body part 11 on the +x axis direction side.

The L-shaped part 12 includes a first extension part 12a and a second extension part 12b. The first extension part 12a extends in the +x axis direction from the end surface of the body part 11 on the +x axis direction side. The second extension part 12b extends in the +z axis direction from an end of the first extension part 12a on the +x axis direction side. A recess 12c is formed at an end of the first extension part 12a on the −z axis direction side in the L-shaped part 12.

The L-shaped part 13 includes a first extension part 13a and a second extension part 13b. The first extension part 13a extends in the +x axis direction from the end surface of the body part 11 on the +x axis direction side. The second extension part 13b extends in the +z axis direction from an end of the first extension part 13a on the +x axis direction side. A recess 13c is formed at an end of the first extension part 13a on the −z axis direction side in the L-shaped part 13. The L-shaped parts 12 and 13 are L-shaped when viewed from the y axis direction.

The L-shaped part 12 is to be inserted into an L-shaped groove 22 formed on a side surface of the die-cast member 20 on the −y axis direction side. The recess 12c is to be fit with a fitting part 32a of the shielding shell 30. The L-shaped part 13 is to be inserted into an L-shaped groove 23 formed on a side surface of the die-cast member 20 on the +y axis direction side. The recess 13c is to be fit with a fitting part 33a of the shielding shell 30.

Note that the “L” shape of the L-shaped parts 12 and 13 may be reversed in the z axis direction. Specifically, the second extension part 12b may extend in the −z axis direction from the end of the first extension part 12a on the +x axis direction side. Further, the second extension part 13b may extend in the −z axis direction from the end of the first extension part 13a on the +x axis direction side. In this case, the structures of the L-shaped grooves 22 and 23 of the die-cast member 20 may be reversed in the z axis direction in accordance with the “L” shape of the L-shaped parts 12 and 13. However, when the above-described specified board is connected to the −z axis direction side, the second extension parts 12b and 13b preferably extend on the +z axis direction side, which is opposite to the direction in which the specified board is connected. As the second extension parts 12b and 13b extend on the +z axis direction side, they can cope with a force in the −z axis direction in which the specified board is connected.

Further, both of the L-shaped parts 12 and 13 are not necessarily formed, and only one of them may be formed. Specifically, the L-shaped part 12 or the like may be disposed on at least any one of the −y axis direction side and the +y axis direction side in the end surface of a body part 11 of the external housing 10 on the +x axis direction side. Further, depending on the orientation of the L-shaped grooves 22 and 23 of the die-cast member 20, the direction in which the second extension parts 12b and 13b extend is not limited to the z axis direction, and they may extend in the y axis direction or in the direction tiled in the y axis direction and the z axis direction.

The external housing 10 contains an insulator as a material. For example, the external housing 10 contains a resin as a material. Note that the external housing 10 may contain an insulator other than a resin as long as it contains an insulator.

### <Die-Cast Member>

The die-cast member 20 includes the body part 21 and the cylindrical part 25. The cylindrical part 25 is connected to an end surface of the body part 21 on the −x axis direction side. The cylindrical part 25 has a cylindrical shape. The body part 21 has a penetrating hole 24 that penetrates it from an end surface on the +x axis direction side to an end surface on the −x axis direction side. The penetrating hole 24 communicates with the cylindrical part 25. Thus, the die-cast member 20 has the penetrating hole 24 that penetrates it from the end surface of the body part 21 on the +x axis direction side to the end surface of the cylindrical part 25 on the −x axis direction side. The penetrating hole 24 is disposed in such a way that its center axis is in the x axis direction. The penetrating hole 24 may communicate with the penetrating hole 14 of the external housing 10. A member such as the contact unit 70 is to be inserted into the penetrating hole 24.

The L-shaped grooves 22 and 23 are formed in the body part 21. Thus, the die-cast member 20 includes the body part 21 and the L-shaped grooves 22 and 23. The L-shaped grooves 22 and 23 function as a mating part configured to mate with the external housing 10.

The L-shaped groove 22 is formed on a side surface of the body part 21 on the −y axis direction side. The L-shaped groove 22 includes a first groove part 22a and a second groove part 22b. The first groove part 22a extends in the +x axis direction from the end surface of the body part 21 on the −x axis direction side. The second groove part 22b extends in the +z axis direction from the end of the first groove part 22a on the +x axis direction side. Thus, the L-shaped groove 22 is L-shaped when viewed from the y axis direction. A part of the body part 21 remains on the −x axis direction side of the second groove part 22b.

The L-shaped groove 23 is formed on a side surface of the body part 21 on the +y axis direction side. The L-shaped groove 23 includes a first groove part 23a and a second groove part 23b. The first groove part 23a extends in the +x axis direction from the end surface of the body part 21 on the −x axis direction side. The second groove part 23b extends in the +z axis direction from the end of the first groove part 23a on the +x axis direction side. Thus, the L-shaped groove 23 is L-shaped when viewed from the y axis direction. A part of the body part 21 remains on the −x axis direction side of the second groove part 23b.

Note that, as described above, when the “L” shape of the L-shaped parts 12 and 13 is reversed in the z axis direction, the structures of the L-shaped grooves 22 and 23 may be reversed in the z axis direction in accordance with the “L” shape of the L-shaped parts 12 and 13. Specifically, the second groove part 22b may extend in the −z axis direction from the end of the first groove part 22a on the +x axis direction side. Further, the second groove part 23b may extend in the −z axis direction from the end of the first groove part 23a on the +x axis direction side.

Further, both of the L-shaped grooves 22 and 23 are not necessarily formed, and only one of them may be formed. Specifically, the L-shaped groove 22 or the like may be formed on at least any one of the −y axis direction side and the +y axis direction side in the body part 21 of the die-cast member 20. Further, depending on the orientation of the L-shaped parts 12 and 13 of the external housing 10, the direction in which the second groove parts 22b and 23b extend is not limited to the z axis direction, and they may extend in the y axis direction or in the direction tiled in the y axis direction and the z axis direction.

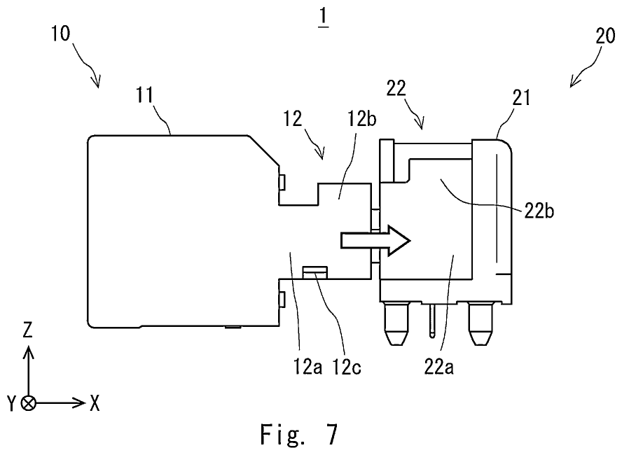

FIGS. 7 to 9 are side views illustrating the operation of connecting the external housing 10 and the die-cast member 20 in the coaxial connector device 1 according to the first embodiment. In FIGS. 7 to 9, members other than the external housing 10 and the die-cast member 20 are omitted. As shown in FIG. 7, in the coaxial connector device 1, the external housing 10 and the die-cast member 20 touch and connect each other in the x axis direction parallel to the axial direction. First, the second extension part 12b of the L-shaped part 12 of the external housing 10 is inserted in the +x axis direction into the first groove part 22a of the L-shaped groove 22. Further, the second extension part 13b of the L-shaped part 13 of the external housing 10 is inserted in the +x axis direction into the first groove part 23a of the L-shaped groove 23.

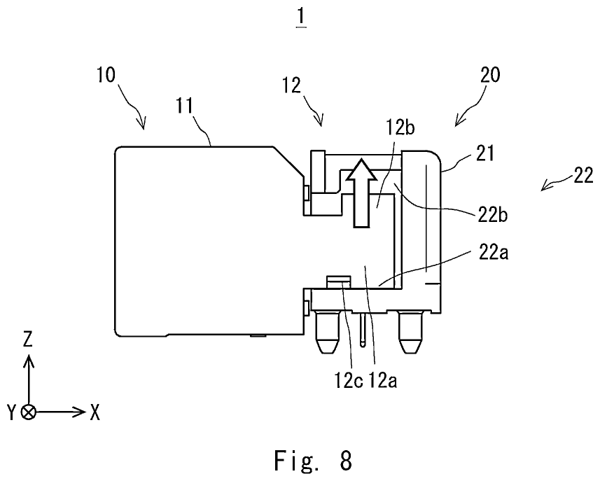

Then, as shown in FIG. 8, the second extension part 12b is inserted in the +x axis direction into the first groove part 22a, the second extension part 12b is inserted in the +z axis direction along the second groove part 22b of the L-shaped groove 22. Likewise, after the second extension part 13b of the L-shaped part 13 of the external housing 10 is inserted in the +x axis direction into the first groove part 23a of the L-shaped groove 23, it is inserted in the +z axis direction along the second groove part 23b of the L-shaped groove 23. In this manner, the L-shaped part 12 of the external housing 10 is formed in such a way that the L-shaped part 12 is inserted into the L-shaped groove 22 of the die-cast member 20. Further, the L-shaped part 13 of the external housing 10 is formed in such a way that the L-shaped part 13 is inserted into the L-shaped groove 23 of the die-cast member 20.

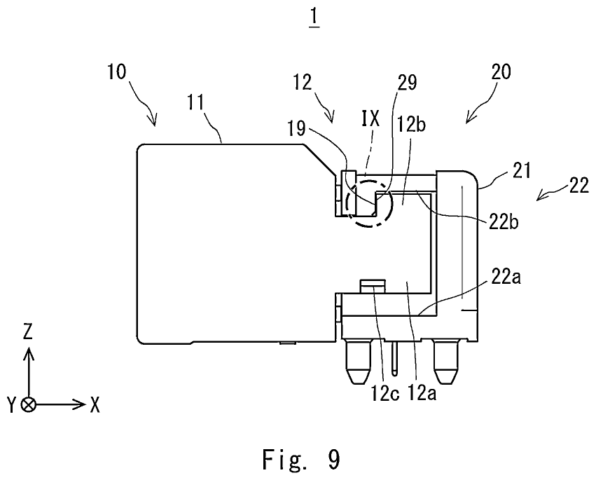

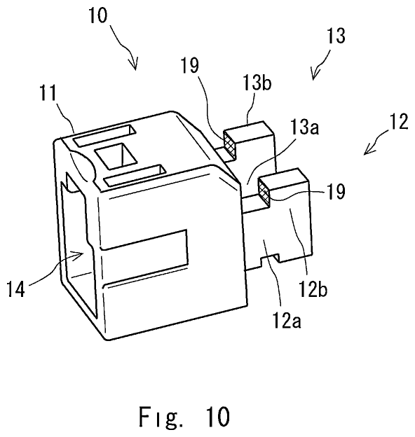

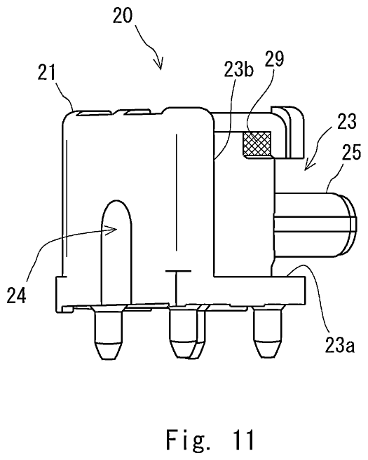

FIG. 10 is a perspective view illustrating the external housing 10 in the coaxial connector device 1 according to the first embodiment. FIG. 11 is a perspective view illustrating the die-cast member 20 in the coaxial connector device 1 according to the first embodiment. As shown in the area IX in FIG. 9 and FIGS. 10 and 11, when the L-shaped part 12 of the external housing 10 is inserted into the L-shaped groove 22 of the die-cast member 20, a surface 19 of the second extension part 12b on the −x axis direction side in the L-shaped part 12 comes into contact with a surface 29 of the second groove part 22b facing the +x axis direction in the L-shaped groove 22. When the L-shaped part 13 of the external housing 10 is inserted into the L-shaped groove 23 of the die-cast member 20, a surface 19 of the second extension part 13b on the −x axis direction side in the L-shaped part 13 comes into contact with a surface 29 of the second groove part 23b facing the +x axis direction in the L-shaped groove 23. In other words, the surface 29 on the +x axis direction side in a part of the body part 21 located on the −x axis direction side of the second groove parts 22b and 23b comes into contact with the surface 19 of the second extension parts 12b and 13b on the −x axis direction side.

The die-cast member 20 contains a conductor as a material. For example, the die-cast member 20 may include a metal such as aluminum and zinc as a material. The die-cast member 20 may be manufactured by die casting. Note that the die-cast member 20 is not limited to be manufactured by die casting, and it may be manufactured by another process such as casting or 3D printer. The die-cast member 20 is electrically connected to a ground (GND), together with the shielding shell 30.

### <Shielding Shell>

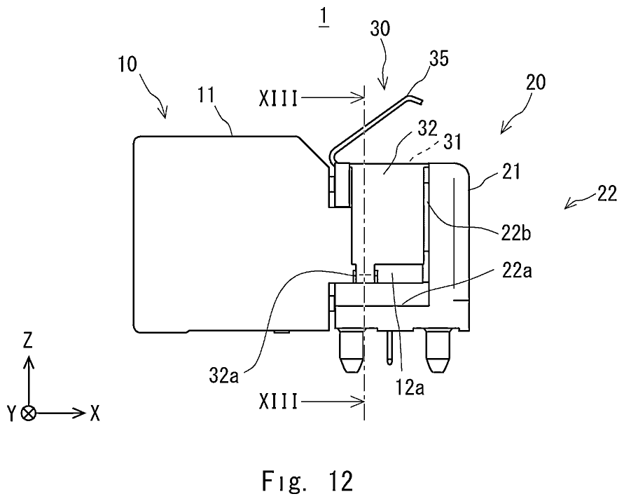

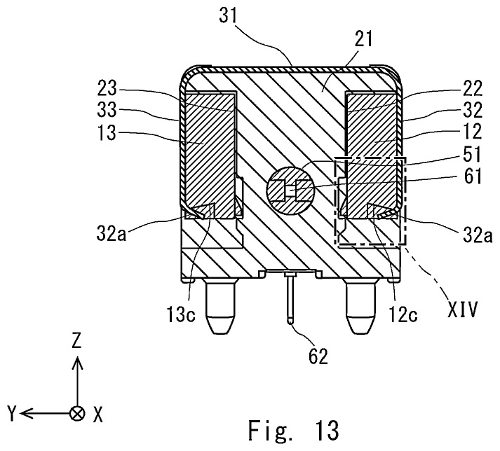

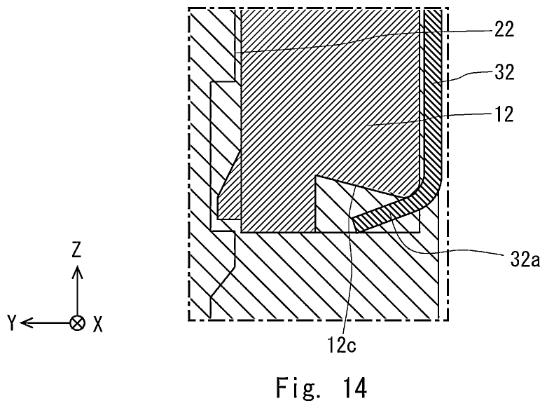

FIG. 12 is a side view illustrating the coaxial connector device 1 according to the first embodiment. FIG. 13 is a sectional view illustrating the coaxial connector device 1 according to the first embodiment, which shows a cross section along line XIII-XIII in FIG. 12. FIG. 14 is a sectional view illustrating the fitting part 33a in the coaxial connector device 1 according to the first embodiment, which shows an enlarged view of a part XIV in FIG. 13.

As shown in FIG. 6 and FIGS. 12 to 14, the shielding shell 30 includes a body part 31, cover parts 32 and 33, fitting parts 32a and 33a, and a spring member 35. The body part 31 has a plate surface on the +z axis direction side and a plate surface on the −z axis direction side. The body part 31 is disposed on a top surface of the die-cast member 20 on the +z axis direction side. The spring member 35 is connected to an end of the body part 31 on the −x axis direction side. The spring member 35 has a plate shape, for example. The spring member 35 is disposed in such a way that its plate surface is inclined against the body part 31. The spring member 35 has spring elasticity. The spring member 35 can thereby bend in the z axis direction.

Each of the cover parts 32 and 33 is in plate shape and has a plate surface on the +y axis direction side and a plate surface on the −y axis direction side. Ends of the cover parts 32 and 33 on the +z axis direction side are respectively connected to both ends of the body part 31 in the y axis direction. The cover part 32 extends in the −z axis direction from the end of the body part 31 on the −y axis direction side in the y axis direction. The cover part 32 covers the L-shaped part 12 in the y axis direction. The fitting part 32a is at the end of the cover part 32 on the −z axis direction side. The fitting part 32a is fit into the recess 12c of the L-shaped part 12. For example, the fitting part 32a is curved on the +y axis direction side to fit into the recess 12c. The fitting part 32a thereby fixes the L-shaped part 12 of the external housing 10.

The cover part 33 extends in the −z axis direction from the end of the body part 31 on the +y axis direction side in the y axis direction. The cover part 33 covers the L-shaped part 13 in the y axis direction. The fitting part 33a is at the end of the cover part 33 on the −z axis direction side. The fitting part 33a is fit into the recess 13c of the L-shaped part 13. For example, the fitting part 33a is curved on the −y axis direction side to fit into the recess 13c. The fitting part 33a thereby fixes the L-shaped part 13 of the external housing 10.

Note that both of the cover parts 32 and 33 are not necessarily formed, and only one of them may be formed. Specifically, the cover part 32 or the like may extend in the −z axis direction from at least any one of the end on the −y axis direction side and the end on the +y axis direction side of the body part 31.

The shielding shell 30 contains a conductor as a material. For example, the shielding shell 30 contains a metal as a material. The shielding shell 30 is electrically connected to the ground (GND), together with the die-cast member 20.

### <Contact Unit>

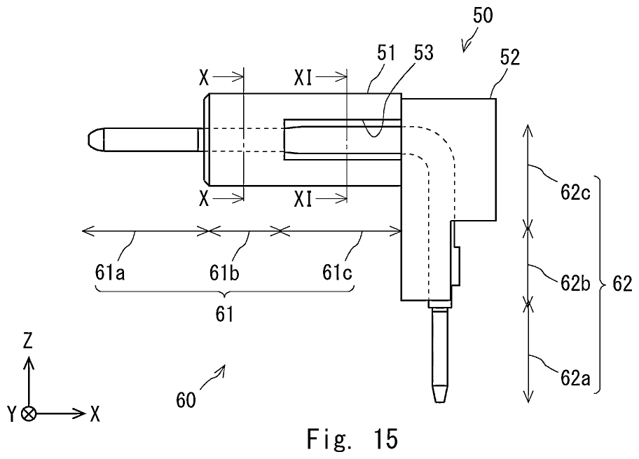

FIG. 15 is a side view illustrating the contact unit 70 in the coaxial connector device 1 according to the first embodiment. As shown in FIG. 15, the contact unit 70 includes a housing 50 and the contact 60. The contact unit 70 is formed by insert molding. Specifically, the contact 60 and the housing 50 are integrated into the contact unit 70 by insert molding. Note that the contact unit 70 may be formed by press-fitting the contact 60 into the housing 50 in the −x axis direction.

The contact 60 is in L shape having a part extending in the x axis direction and a part extending in the z axis direction. The part extending in the x axis direction is referred to as a first bar-shaped part 61, and the part extending in the z axis direction is referred to as a second bar-shaped part 62. An end of the first bar-shaped part 61 on the +x axis direction side is connected to an end of the second bar-shaped part 62 on the +z axis direction side.

The first bar-shaped part 61 includes a distal end part 61a, a middle part 61b, and a root part 61c, for example. The distal end part 61a has a round bar shape. A distal end of the distal end part 61a is rounded in hemispherical shape. The middle part 61b and the root part 61c have a square bar shape. Thus, the first bar-shaped part 61 includes a part in square bar shape. The middle part 61b and the root part 61c are collectively referred to as a middle-root part in some cases. The middle-root part is connected to the distal end part 61a. The width between opposed side surfaces of the middle part 61b and the root part 61c in square bar shape is greater than the outside diameter of the distal end part 61a in round bar shape. No projection is formed on the side surfaces of the middle part 61b and the root part 61c, unlike the contact 160 according to the comparative example. Note that the middle part 61b and the root part 61c may have a round bar shape. Specifically, the first bar-shaped part 61 may include a part in round bar shape.

A part of the first bar-shaped part 61 in the contact 60 is incorporated into the housing 50 by insert molding. To be specific, for example, the middle-root part in the first bar-shaped part 61 is incorporated into the housing 50. On the other hand, the distal end part 61a in the first bar-shaped part 61 projects from the end surface of a tubular part 51 on the −x axis direction side in the housing 50.

The second bar-shaped part 62 includes a distal end part 62a, a middle part 62b, and a root part 62c, for example. The distal end part 62a has a round bar shape. A distal end of the distal end part 62a is rounded in hemispherical shape. The middle part 62b and the root part 62c have a square bar shape. Thus, the second bar-shaped part 62 includes a part in square bar shape. The middle part 62b and the root part 62c are collectively referred to as a middle-root part in some cases. The middle-root part is connected to the distal end part 62a. The width between opposed side surfaces of the middle part 62b and the root part 62c in square bar shape is greater than the outside diameter of the distal end part 62a in round bar shape. A projection may be formed on a side surface of the middle part 62b on the +x axis direction side.

In this manner, the contact 60 includes the distal end part 61a that projects from the housing 50 and the middle-root part that is connected to the distal end part 61a. Further, the contact 60 includes the distal end part 62a that projects from the housing 50 and the middle-root part that is connected to the distal end part 62a. At least part of the middle-root part is incorporated into the housing 50.

The contact 60 contains a conductor as a material. For example, the contact 60 contains a metal as a material. The contact 60 serves as a transmission path of a high-frequency signal.

The housing 50 includes a tubular part 51 and a support part 52. The tubular part 51 has a cylindrical shape, for example. Note that the tubular part 51 is not limited to be cylindrical as long as it is tubular. The tubular part 51 is disposed in such a way that its center axis is in the x axis direction. The tubular part 51 in the housing 50 encapsulates a part of the contact 60. The housing 50 thereby incorporates a part of the contact 60. To be specific, the tubular part 51 incorporates the middle part 61b and the root part 61c of the first bar-shaped part 61 of the contact 60.

The tubular part 51 has a hole 53 on its side surface. Note that the support part 52 may have the hole 53. A part of the contact 60 is exposed through the hole 53. A part of the contact 60 may come into contact with air through the hole 53. In this manner, the housing 50 has at least one hole 53 through which a part of the contact 60 is exposed. For example, the housing 50 has at least one hole 53 through which a part of the middle-root part is exposed. The hole 53 is formed sideward of the tubular part 51 in the y axis direction, for example.

The housing 50 may have a plurality of holes 53. The plurality of holes 53 may be opposed to each other with the center axis of the contact 60 interposed therebetween. The coaxial connector device 1 thereby allows uniformizing the impedance of parts opposed to each other with the center axis of the contact 60 interposed therebetween. For example, when the middle-root part of the first bar-shaped part 61 includes a part in square bar shape, a part of opposed flat side surfaces is exposed through the plurality of holes 53. When the middle-root part of the first bar-shaped part 61 includes a part in round bar shape, a part of opposed curved side surfaces may be exposed through the plurality of holes 53.

The plurality of holes 53 may be one pair of holes that are opposed to each other with the center axis of the contact 60 interposed therebetween, or may be a plurality of pairs of holes that are opposed to each other with the center axis of the contact 60 interposed therebetween. The plurality of holes 53 may be formed in a discrete manner around the center axis. The plurality of holes 53 may be formed by using a holding member that supports the contact 60 during insert molding.

The support part 52 is connected to the +x axis direction side of the tubular part 51. The support part 52 is in plate shape extending in the z axis direction, which has plate surfaces on the +x axis direction side and the −x axis direction side. The tubular part 51 is connected to the +z axis direction side in the plate surface of the support part 52 on the −x axis direction side. Thus, when viewed from the y axis direction, the housing 50 is L-shaped.

The housing 50 contains an insulator as a material. For example, the housing 50 contains a resin as a material. Note that the housing 50 may contain an insulator other than a resin as long as it contains an insulator.

### <Method of Assembly>

The contact unit 70 is inserted into the penetrating hole 24 of the die-cast member 20 in the −x axis direction. The tubular part 51 extending in the x axis direction in the housing 50 is disposed between the first bar-shaped part 61 extending in the x axis direction in the contact 60 and the die-cast member 20. The L-shaped parts 12 and 13 of the external housing 10 mate with the L-shaped grooves 22 and 23 of the die-cast member 20. The cover parts 32 and 33 cover the L-shaped parts 12 and 13 from sideward, respectively. The recesses 12c and 13c are fit with the fitting parts 32a and 33a, respectively. A member such as the contact unit 70 is inserted into the penetrating hole 14 of the external housing 10 and the penetrating hole 24 of the die-cast member 20.

An advantageous effect of this embodiment is described hereinafter. In the coaxial connector device 1 according to this embodiment, the external housing 10 includes the L-shaped part 12 or the like, and the die-cast member 20 includes the L-shaped groove 22 or the like. In the coaxial connector device 1, the L-shaped part 12 or the like and the L-shaped groove 22 or the like mate with each other, and thereby the surface 19 of the second extension part 12b on the −x axis direction side comes into contact with the surface 29 of the second groove part 22b facing the +x axis direction. In this manner, the external housing 10 and the die-cast member 20 have the surfaces 19 and 29 facing a direction perpendicular to a specified board to thereby receive a force from the x axis direction (for example, the horizontal direction).

As described above, the coaxial connector device 1 has a structure of “locking up” the L-shaped part 12 or the like and the L-shaped groove 22 or the like, which improves the retention in the x axis direction of the external housing 10 and the die-cast member 20. The connection reliability of the coaxial connector device 1 is thereby improved. To be specific, this contributes to the retention in the x axis direction until the contacting surfaces 19 and 29 of the external housing 10 and the die-cast member 20 enter a breakdown mode.

Further, in the coaxial connector device 1 according to this embodiment, the cover part 32 or the like covers the L-shaped part 12 or the like, and the fitting part 32a or the like is fit into the recess 12c or the like of the L-shaped part 12 or the like. In this structure, the shielding shell 30 of the coaxial connector device 1 covers the L-shaped part 12 or the like of the external housing 10 and reduces displacement of the L-shaped part 12 or the like in the z axis direction. The connection reliability is thereby further improved.

Although an embodiment of the present disclosure is described in the foregoing, the present disclosure involves appropriate modifications without impairment of its object and effects and is not restricted to the above-described embodiment. Further, the structures in the comparative example and the first embodiment may be appropriately combined.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A coaxial connector device comprising:
an external housing containing an insulator; and
a die-cast member containing a conductor,
the external housing and the die-cast member adjacent and connected each other in a first direction parallel to an axial direction, wherein
the external housing includes:
a first body part; and
an L-shaped part including a first extension part extending from an end surface of the first body part on one side in the first direction toward the one side in the first direction, and a second extension part extending from an end of the first extension part on the one side in the first direction toward one side in a second direction orthogonal to the first direction,
the die-cast member includes:
a second body part; and
an L-shaped groove including a first groove part extending from an end surface of the second body part on another side in the first direction toward the one side in the first direction, and a second groove part extending from an end of the first groove part on the one side in the first direction toward the one side in the second direction, and
a surface of the second extension part on another side in the first direction is in contact with a surface of the second groove part facing the one side in the first direction.

2. The coaxial connector device according to claim 1, wherein
the L-shaped groove is formed in at least one of a surface of the second body part on one side in a third direction orthogonal to the first direction and the second direction and a surface of the second body part on another side in the third direction, and
the L-shaped part is disposed on at least one of the one side in the third direction and the another side in the third direction in a surface of the second body part on the one side in the first direction.

3. The coaxial connector device according to claim 2, wherein the L-shaped groove is formed in such a way that after the second extension part of the L-shaped part is inserted into the first groove part of the L-shaped groove on the one side in the first direction, the second extension part of the L-shaped part is inserted into the second groove part of the L-shaped groove on the one side in the second direction.

4. The coaxial connector device according to claim 2, further comprising:
a shielding shell containing the conductor,
wherein the shielding shell includes:
a third body part disposed on a surface of the second body part on the one side in the second direction;
a spring member in spring shape connected to the third body part;
a cover part extending from at least one of an end of the third body part on the one side in the third direction and an end of the third body part on the another side in the third direction toward another side in the second direction, and configured to cover the L-shaped part in the third direction; and
a fitting part formed at an end of the cover part and configured to be fit into a recess of the L-shaped part.

5. The coaxial connector device according to claim 4, wherein the spring member and the die-cast member are connected to a ground potential.

6. The coaxial connector device according to claim 1, further comprising a contact unit including:
a contact containing the conductor; and
a housing containing the insulator,
wherein a part of the housing extending in the axial direction is disposed between a part of the contact extending in the axial direction and the die-cast member.
